(19) United States
(12) Patent Application Publication
(10) Pub. No.: US 2012/0041718 A1
(43) Pub. Date: Feb. 16, 2012

(54) DEVICE AND METHOD FOR DETECTING CHARACTERISTICS OF SECURITIES

(75) Inventor: Andreas Schreckenberg, Brilon (DE)

(73) Assignee: BEB INDUSTRIE-ELEKTRONIK AG, Burgdorf (CH)

(21) Appl. No.: 13/265,268

(22) PCT Filed: Apr. 20, 2010
(86) PCT No.: PCT/EP2010/002403

§ 371 Date: Oct. 19, 2011

(30) Foreign Application Priority Data
Apr. 21, 2009 (DE) 10 2009 017 986.0

(51) Int. Cl. G06K 9/62; G06K 19/00

(52) U.S. Cl. 702/189; 356/71

(57) ABSTRACT

A device and a method for detecting characteristics of a flat object, in particular a security, are proposed. To this end, the device has at least one light source that illuminates the object with light, at least one sensor that captures the light reflected and/or emitted by the object, where the sensor is a computer mouse sensor of an optical computer mouse, and a transport device that transports the object relative to the light source and the sensor in a transport direction.

### CROSS-REFERENCE TO RELATED APPLICATIONS

This application is a National Stage of International Application No. PCT/EP2010/002403, filed Apr. 20, 2010 and published in German as WO/2010/121779 on Oct. 28, 2010. This application claims the benefit and priority of German application 10 2009 017 986.0, filed Apr. 21, 2009. The entire disclosures of the above applications are incorporated herein by reference.

### BACKGROUND

This section provides background information related to the present disclosure which is not necessarily prior art.

1. Technical Field

The invention relates to a device and method for detecting characteristic of a flat object, specifically of a security.

2. Discussion

Such devices are used for the inspection of flat objects. Said inspection includes, for example, the detection, checking, verification of and testing the genuineness of objects and the identification of forgeries. The objects specifically include securities or documents such as bank notes, checks, stocks, papers with a security imprint, deeds, admission tickets or travel tickets, credit vouchers, but also credit or automated teller machine cards, identification or access cards. Devices for detecting characteristics of an object are often an integral part of a system consisting of a plurality of components for handling and processing flat objects. Devices for detecting characteristics serve to distinguish counterfeit from genuine objects. To this end, the objects are given characteristic features that are also described as security characteristics. They are intended to make counterfeiting the objects more difficult and assist in the inspection of the objects. The security characteristics of objects include, for example, the material of the object, a water mark, a special printing ink, in particular an optically variable printing ink, holograms, phosphorescent or fluorescent patterns and security threads. To inspect optical security characteristics in particular, devices are known that are equipped with a transport device to transport flat objects, have a lighting device to light the objects being transported and a sensor to detect the light reflected and/or emitted by the object. The disadvantage is that the components of the device are complex and expensive, require a great deal of space and thus limit their use for special applications.

### SUMMARY OF THE INVENTION

An object of the invention is to provide a device and a method for detecting characteristics of a flat object that permit a rapid and cost-effective inspection of flat objects and still have small dimensions. The device is distinguished by the fact that it is equipped with at least one optical sensor of an optical computer mouse. Such sensors possess the advantage that they have a mini-camera system with its own optical system, two-dimensional sensor chip, analog/digital converter and an interface. The sensor is capable of taking images with a high repetition rate. This typically amounts to between 1,500 and 7,000 images per second and more. An interface allows these images to be read quickly to inspect them for the presence of characteristics. This high repetition rate makes it possible for images of bank notes to be captured that are transported at high speed past the optical sensor of the computer mouse. Such high transport speeds are the norm in machines for machine handling and processing of bank notes because large numbers must be captured in short periods.

A typical image size for such sensors is between 16×16 and 30×30 pixels, for example. As a result, high-resolution and greatly enlarged images of the objects can be generated. The characteristics of the objects are determined from the images taken by the sensor using image processing.

Characteristics captured are, for example, the front edge in the transport direction of the object, the rear edge in the transport direction, and the transmission or reflection of an object. It can be determined from these characteristics whether an object has been transported past the sensor. Furthermore, the objects can be counted. Security characteristics of an object can be captured with the aid of other sensors that are specially adapted to the specific security characteristics. It does not have to be a computer mouse sensor. These other sensors can be activated, for example, only when the computer mouse sensor registers the presence of an object. In addition, optically detectable characteristics of the objects can be determined using the computer mouse. All the physical properties of an object count among its characteristics.

In addition to detecting characteristics of objects, it is possible to qualify different quality criteria using the device and the method in accordance with the invention. This includes, for example, detecting an adhesive strip on the object, soiling of or damage to the object or wear to the object.

The computer mouse sensor is small and typically arranged at a short distance from the objects. The result is that the device is compactly dimensioned.

### DETAILED DESCRIPTION OF THE PREFERRED EMBODIMENTS

In accordance with an advantageous embodiment of the invention, the device is furnished with a processor that evaluates the light captured by the sensor to detect characteristics. In a preferred manner, the optical sensor converts the incident light into electrical signals. These electrical signals are evaluated by the processor.

In accordance with a further advantageous embodiment of the invention, the light source is likewise a component of an optical computer mouse.

In accordance with a further advantageous embodiment of the invention, the device has an interface compatible with a microcontroller. Said interface allows the images recorded by the sensor to be read at high speed.

In accordance with a further advantageous embodiment of the invention, the light source is a light-emitting diode.

In accordance with a further advantageous embodiment of the invention, the light source is a laser. It may involve a diode laser, for example. The surface structures of the flat objects can be resolved with greater accuracy using a laser rather than an LED. Objects having a monochromatic, smooth and/or shiny surface can be captured better by using a laser than by using an LED. The use of lasers as a light source further makes it possible to light the objects with coherent radiation. With an optically rough surface for the objects, having irregularities within the range of the wavelength of the laser, speckle patterns or light granulation show up that can be used to the full to detect characteristics of the objects. The device can be furnished with laser and LED as an alternative or cumulatively.

In accordance with a further advantageous embodiment of the invention, a plurality of sensors is arranged next to each other to form a multichannel sensor apparatus so that an image of the entire surface area of the flat objects can be recorded.

In accordance with a further advantageous embodiment of the method in accordance with the invention, one or more speckle patterns on the object are evaluated. Said evaluation involves granular interference phenomena that occur with coherent irradiation of the surface of the objects as long as the surface unevenness is within the range of the wave length. Evaluation of the speckle patterns provides an indication of the surface nature of the flat objects.

All features of the invention can be essential to the invention both individually and in any combination with each other.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A device for detecting characteristics of a flat object, in particular of a security, having at least one light source that illuminates the object with light, said device comprising at least one sensor that captures the light reflected or emitted by the object, where the sensor is a computer mouse sensor of an optical computer mouse, and having a transport device that transports the object relative to the light source and the sensor in a transport direction.

2. The device according to claim 1, wherein it is furnished with a processor that evaluates the light captured by the sensor to detect the characteristics.

3. The device according to claim 1, wherein the light source is a component of an optical computer mouse.

4. The device according to claim 1, wherein it has an interface compatible with a microcontroller.

5. The device according to claim 1, wherein the light source is a light-emitting diode LED.

6. The device according to claim 1, wherein the light source is a laser.

7. The device according to claim 1, wherein a plurality of sensors is arranged next to each other to form a multichannel sensor apparatus.

8. A method for detecting characteristics of a flat object, in particular of a security, comprising:
Transporting the object using a transport device in a transport direction,
Illuminating the object using at least one light source,
Capturing the light reflected and/or emitted by the object using a computer mouse sensor of an optical computer mouse,
Converting the light captured into one or more signals, and
Evaluating the signals to determine the characteristics of the object.

9. A method according to claim 8, wherein the object is illuminated using the light source from an optical computer mouse.

10. A method according to claim 8, wherein the object is illuminated with coherent light.

11. A method according to claim 10, wherein one or more speckle patterns on the objects are evaluated.
